(19) United States
(12) Patent Application Publication
(10) Pub. No.: US 2005/0092394 A1
(43) Pub. Date: May 5, 2005

(54) Holding device for molded baskets

(76) Inventor: Eric Taylor, Danbury, NH (US)

Correspondence Address: GEORGE E. KERSEY, P.O. Box 1073, Framingham, MA, 01701, US

(21) Appl. No.: 10/699,032

(22) Filed: Nov. 3, 2003

(51) Int. Cl. B27J 1/00

(52) U.S. Cl. 147/48

(57) ABSTRACT

Method and Apparatus for making a basket, positioned on a basket mold on a frame. A holder mountable upon a support surface is adjustable with respect to the support surface, and the holder is connected to the frame that supports the basket mold with the basket thereon.

### REFERENCES

U.S. Patent Documents

| | | | |
|---|---|---|---|
| 124231 | March, 1872 | Tower | 217/122. |
| 763580 | June, 1904 | Walker | 217/122. |
| 1311086 | July, 1919 | O'Loughlin | 217/122. |
| 1933879 | November, 1933 | Thayer | 147/48. |
| 2265820 | December, 1941 | Scanlan | 147/48. |
| 4,678,016 | July, 1987 | Hall | 147/48. |

### BACKGROUND OF THE INVENTION

This invention relates to the hand weaving of baskets and, more particularly, to a method and apparatus machine for supporting a basket while being woven.

Basket making, commonly employs machines having a drive mechanism for rotating the basket during the weaving as illustrated by U.S. Pat. No. 1,933,879, which issued to Thayer in 1933. Similarly, U.S. Pat. No. 2,322,363, which issued to James, shows the formation of basket warp and weave around a mold with an electric motor, driven by a belt and a pulley for operating a gear reduction unit to move a clamping mechanism.

The use of machinery to rotate a basket weaving mold can interfere with the need for carefully controlling the weave pattern when the pattern entails any unusual degree of sophistication and intricacy.

Accordingly, there is a need for a weaving system that permits the production of baskets having unusual and intricate styling.

There is a need for a simple and efficient system for hand weaving operations.

It is therefore a further object of the invention to provide an improved system for the hand weaving of baskets.

Another object is to provide an improved arrangement for basket components on a basket mold for hand weaving.

Another object is to provide an improved method for holding basket components in place during the weaving procedure.

### SUMMARY OF THE INVENTION

In accomplishing the foregoing and related objects, the invention provides for making a basket on a basket mold positioned on a frame. A holder mountable upon a support surface is adjustable with respect to the support surface, and the holder is, connected to the frame on which the basket mold is positioned.

In accordance with one aspect of the invention, the holder includes a top surface, a front surface, and a back surface. The back surface includes a groove therein to permit the holder to be adjustably positioned with respect to the support surface. A clamp is positionable in the groove for adjustable placement of the holder on the support surface.

In accordance with another aspect of the invention, an insert into the holder secures the position of the clamp therein. The holder includes an aperture for receipt of a connector from the frame to the holder.

In accordance with a further aspect of the invention, the aperture is positioned in the front surface of the holder. The holder has an auxiliary surface diagonally disposed between the upper surface and the frontal surface and an aperture for the connector can be positioned therein.

In accordance with still another aspect of the invention, the holder can include a plurality of apertures therein for receipt of the connector from the frame to the holder.

In accordance with a method of the invention for making a basket, the steps include (a) providing a basket mold on a frame, (b) mounting a holder upon a support surface, (c) adjusting the holder with respect to the support surface, and (d) connecting the frame to the holder.

The method further includes the step of providing the holder with a top surface, a front surface, and a back surface. The back surface has a groove to permit the holder to be adjustably positioned with respect to the support surface. A clamp is positionable in the groove for adjustable placement of the holder on the support surface.

The method also includes the step of inserting a member into the holder for securing the position of the clamp therein. Included in the holder is an aperture for receipt of the connector of the frame to the holder. An aperture is positionable in the front surface of the holder, and the holder can have an auxiliary surface diagonally disposed between the upper surface and the frontal surface with an aperture therein. The holder can be provided with a plurality of apertures for receipt of the connector for connection of the frame to the holder.

### DESCRIPTION OF THE DRAWINGS

FIG. 1 is a perspective view of a system in accordance with the invention for expediting the hand weaving of baskets.

FIG. 2 is a perspective view of the adjustable mount that is used by the invention for expediting the hand weaving of baskets.

FIG. 3 is a rear view of the adjustable mount of FIG. 2 showing the groove by which the mount can be adjusted with respect to a support surface.

FIG. 4 is a side view of the mount of FIG. 3, adjustably positioned on a support surface by a clamp.

FIG. 5A is a side view of the mount of FIG. 3 illustrating the apertures that extend into the mount for a supporting rod that extends from the mount to the mold that holds the basket shown in FIG. 1.

FIG. 5B is a top view of the mount of FIG. 3 illustrating the top apertures that extend into the mount for a supporting rod that extends from the mount to the mold that holds the basket shown in FIG. 1, and the groove .for the adjustable clamp by which the mount is held in position on a work surface.

### DETAILED DESCRIPTION

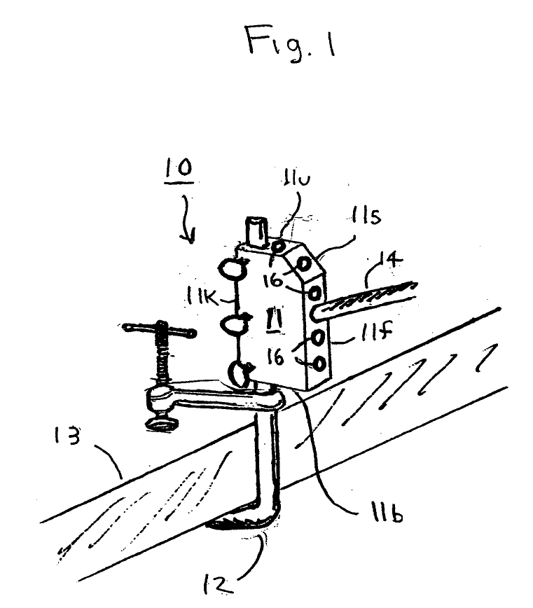

With reference to the drawings, FIG. 1 illustrates a system 10 of the invention for making hand woven baskets. The system 10 includes a mount or frame 11, having a longitudinally extending base member 11b with a frontal surface 11f extending upwardly therefrom to an inclined surface 11s that joins an upper surface 11u.

The mount 11 has a rear surface with an elongated groove 11g that supports a member such as a clamp 12 by which the mount 11 can be adjustably positioned on a support surface 13. As a result, the system permits a worker to elevate and lower the mount 11 to a position that is compatible with the weaving operation that he/she is undertaking. The support surface 13 illustratively is the top of a table or any other structure to which the mount 11 can be conveniently attached.

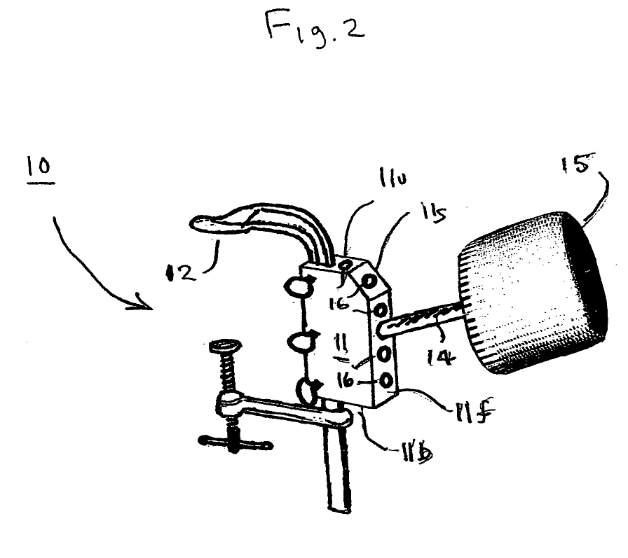

Extending from the mount 11 is an elongated connector or leg 14 that connects the basket mold within the basket 15 to the mount 11 as shown in FIG. 2. Because the mount 11 has a plurality of apertures 16 that extend within the mount 11, the elongated connector 14 can be variously positioned at different angles in relation to the person weaving the basket.

Accordingly, the invention provides two degrees of freedom for the position of the mount and the connector in relation to the basket weaver. The weaver (not shown) can adjust the height of the mount in relation to the support surface 13 as discussed above, and can change the angle of elevation of the connecting rod 14. As a result, the basket weaving procedure provided by the invention facilitates the creation, not only of ordinary baskets, but of those having special or unusual design characteristics.

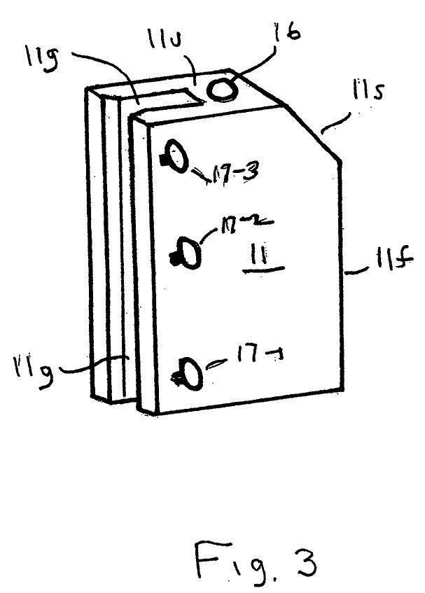

As shown in FIG. 3, which is a rear view of the adjustable mount 11 of FIG. 2, the groove 11g by which the mount 11 can be adjusted with respect to the support surface 13, has side walls 11s that permit slidable movement of the member, such as the clamp 12 that is held in a selected position by a member such as a threaded screw 17. In order to prevent inadvertent movement of the mount 11 after a particular position has been selected, the mount 11 of FIG. 3 has three securing screws 17-1 through 17-3. It will be appreciated that other arrangement maybe made for securing the clamp 12 to the mount 11 or providing an alternative fix of the mount 11 to the support surface 13.

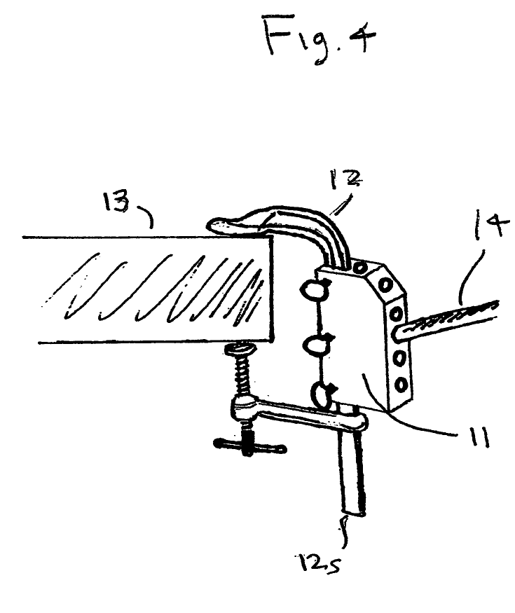

In FIG. 4, which is an alternative view of the mount 11 of FIG. 1, the mount 11 has been adjustably positioned on the support surface 13 by placing the mount 11 at an alternative position in relation to the clamp 12. It will be appreciated that the invention accommodates any one of the various positions that can be assumed by the mount 11 in relation to the clamp 12 as the mount 11 is slidably positioned along the clamp 12.

In order to provide added flexibility in establishing a particular position, a side rail 12s can be added to the clamp 12, so that the number of positions can be increased to accommodate any desired elevation in relation to the worker involved in the hand weaving of a basket.

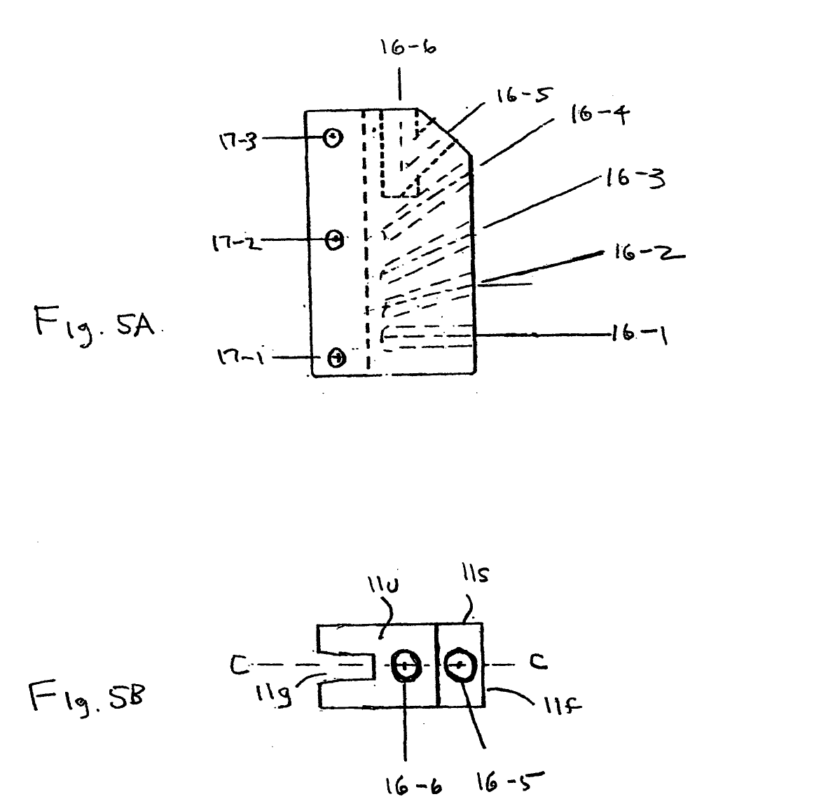

As shown in FIG. 5A, which is a side view of the mount 11 of FIG. 3, elongated apertures 16-1 through 16-6 extend into the mount 11 for a supporting rod 14 that extends from the mount 11 to the mold that holds the basket 15 shown in FIG. 1. The apertures 16-1 through 16-6 permit the rod 14 to adopt various angular positions extending from the 90° position relative to the vertical for elongated aperture 16-1 to the 0° position relative to the vertical for elongated aperture 16-6. The apertures 16-2, 16-3 and 16-4 are respectively at about 80, 70 and 60 degrees relative to the vertical.

In an illustrative embodiment of the invention the mount 11 had a base 11b that measures 1.500 inches and a height of 2.50 inches. The centerline of the aperture 16-1 was 0.323 inches from the base 11b, while the apertures 16-2 through 16-4 were respectively 0.830, 1.300 and 1.764 inches from the base 11b. The three securing screws 17-1 through 17-3 were respectively positioned 0.250, 1.250 and 2.250 inches from the base 11b. Each of the apertures 16-1 through 16-6 had a depth of about) 0.800 inches and a diameter of 0.313 inches.

In FIG. 5B, which is a top view of the mount 11 of FIG. 3, the top apertures 16-5 and 16-6 are positioned along a center line C-C and the groove 11g extends by about 0.510 inches into the mount 11 from the back 11k, which has width, illustratively, of 0.250 inches. The groove 11g has a tapered opening that angles about 0.156 inches from a width of about 0.312 inches to a width of about. 0.260 inches. The distance from the back 11k to the uppermost aperture 16-6 was about 0.820 inches.

The foregoing detailed description is illustrative only and that adaptations, modifications, and alterations of the invention may be made by those of ordinary skill in the art without departing from the spirit and scope of the invention as defined in the appended claims.

1. Apparatus for making a basket comprising;
a basket mold on a frame,
a holder mountable upon a support surface,
said holder being adjustable with respect to said support surface, and
means for connecting said frame to said holder.

2. Apparatus as defined in claim 1, wherein said holder includes a top surface, a front surface, and a back surface.

3. Apparatus as defined in claim 2, wherein said back surface includes a groove therein to permit said holder to be adjustably positioned with respect to said support surface.

4. Apparatus as defined in claim 3, wherein a clamp is positionable in said groove for adjustable placement of said holder on said support surface.

5. Apparatus as defined in claim 4, further including means insertable into said holder for securing the position of said clamp therein.

6. Apparatus as defined in claim 2, wherein said holder includes an aperture therein for receipt of said means for connecting said frame to said holder.

7. Apparatus as defined in claim 6, wherein said aperture is positioned in the front surface of said holder.

8. Apparatus as defined in claim 2, wherein said holder has an auxiliary surface diagonally disposed between said upper surface and said frontal surface.

9. Apparatus as defined in claim 8, wherein said auxiliary surface has an aperture therein for receipt of said means for connecting said frame to said holder.

10. Apparatus as defined in claim 2, wherein said holder includes a plurality of apertures therein for receipt of said means for connection said frame to said holder.

11. A method for making a basket comprising the steps of,
(a) providing a basket mold on a frame,
(b) mounting a holder upon a support surface,
(c) adjusting said holder with respect to said support surface, and
(d) connecting said frame to said holder.

12. The method as defined in claim 11, furthering including the step of providing said holder with a top surface, a front surface, and a back surface.

13. The method as defined in claim 12, furthering including the step of providing said back surface with a groove to permit said holder to be adjustably positioned with respect to said support surface.

14. The method as defined in claim 13, further including the step of positioning a clamp in said groove for adjustable placement of said holder on said support surface.

15. The method as defined in claim 14, further including the step of inserting means into said holder for securing the position of said clamp therein.

16. The method as defined in claim 12, further including the step of including in said holder an aperture for receipt of said means for connecting said frame to said holder.

17. The method as defined in claim 16, further including the step of positioning said aperture in the front surface of said holder.

18. The method as defined in claim 12, further including the step of providing said holder with an auxiliary surface diagonally disposed between said upper surface and said frontal surface.

19. The method as defined in claim 18, further providing the step of providing said auxiliary surface with an aperture for receipt of said means for connecting said frame to said holder.

20. The method as defined in claim 12, further including the step of providing said holder with a plurality of apertures for receipt of said means for connection said frame to said holder.
